(19) United States
(12) Patent Application Publication
(10) Pub. No.: US 2012/0106175 A1
(43) Pub. Date: May 3, 2012

(54) Lamp protective cover

(75) Inventor: Yutaka Taniguchi, Hyogo (JP)

(73) Assignee: USHIO DENKI KABUSHIKI KAISHA, Tokyo (JP)

(21) Appl. No.: 13/317,640

(22) Filed: Oct. 25, 2011

(30) Foreign Application Priority Data
Nov. 1, 2010 (JP) 2010-244908

(51) Int. Cl. F21V 15/01

(52) U.S. Cl. 362/375

(57) ABSTRACT

A protective cover for a high pressure lamp enclosing gas inside a luminous tube endures momentary pressure created by the rupturing of the high pressure lamp. The protective cover includes two resin half-body containers that freely open and close and a stopper that limits the half-body containers from rotating when the protective cover is in a closed condition.

### CROSS-REFERENCES TO RELATED APPLICATION

This application claims priority from Japanese Patent Application Serial No. 2010-244908 filed Nov. 11, 2010, the contents of which are incorporated herein by reference in their entirety.

### TECHNICAL FIELD

The present invention pertains to protective lamp covers. In particular, it pertains to protective lamp covers where a glass-made luminous tube encloses a high-pressure gas.

### BACKGROUND

Short-arc discharge lamps that are used for the light on source for digital cinema, and the like, have a glass-made luminous tube that encloses a discharge gas such as xenon, at a higher pressure than the atmospheric pressure. In the unlikely situation when such discharge lamps are ruptured, glass fragments scatter in the surroundings and it is extremely hazardous, and therefore, when they are not lit, for example, during transportation and storage, they are placed and handled in a protective cover.

For example, Japanese Unexamined Application Publication Showa 58-138313 discloses a protective cover for this type of short-arc discharge lamps, with a structure by which the body of a container, which is split in half, closes and opens by rotating around an axis that is in a longitudinal direction. FIG. 5 shows the structure. In addition, Japanese Unexamined Patent Application Publication No. 2009-541961 discloses a protective cover with two symmetrical half-shell shapes, which are cut in parallel along the longitudinal axis of the lamp.

FIG. 5 is an overall view of a protective lamp cover of the background art (patent literature 1). protective cover 60 of lamp 50 is an approximately box-shaped container, having a containing part 61 where light emitting part 51 of lamp 50 is contained at the center, and having neck parts 62 and 62 where both ends in the lamp tube direction are narrowed. The containing part 61 at the center of the protective cover has a containing space where its cubic capacity is larger than that of neck parts 62. This protective cover 60 is comprised of two half bodies 63 and 64, which are horizontally cut along the lamp tube axis direction and approximately symmetrically split. And they are connected by a shaft 65, which is located by extending in the same direction as the lamp tube direction. And therefore, it is a structure such that the half bodies 63 and 64 rotate along the shaft that acts as an axis, allowing opening and closing of the protective cover 60.

Although it is not illustrated, when the protective cover is closed, an appropriate stopper is provided to maintain its condition. With the above-mentioned mechanism, even in the unlikely event that a lamp is broken, the fragments of glass are encased in the protective cover without being scattered and thus, it does not pose a risk to the surrounding area.

### BACKGROUND ART DOCUMENTS

[Patent Literature 1] Japanese Unexamined Application Publication Show a 58-136313

[Patent Literature 2] Japanese Unexamined Patent Application Publication No. 2009-541961

### SUMMARY

Recently, because the pressure of the discharge gas enclosed in the short-arc discharge lamps has increased current protective covers can not contain the higher intensity. That is, when a lamp ruptures in current protective covers it breaks the locking mechanism and rips open the protective cover because the pressure of the gas cannot be compared to past high-pressure lamps. As a means to solve such a problem, forming a vent on the protective cover was considered. Yet, further problems existed, in that holes big enough for the broken pieces of glass to go through would have no meaning, and smaller holes require time for the gas to pass through, which does not reduce the pressure at the moment of a lamp rupture.

The objective is to provide a protective cover for lamps having a glass-made luminous tube where high pressure gas is enclosed inside, wherein said protective cover can endure the momentary pressure of a high pressure gas when the lamps rupture.

To solve the above-mentioned issue, the present invention relates to a protective cover that surrounds the light emitting part of the lamp, comprising an axis; two resin half-body containers that freely open and close and that connect in a rotatable manner around said axis; a lamp containing part provided inside said half-body containers; two edge surface parts that are each respectively located at edges of said lamp containing parts, that are adjacent when the protective cover is in the closed position, and that extended in an axis direction along the edges of said lamp containing parts; a protruding part that extends perpendicularly to said axis direction in the lamp containing part from at least one of the half-body containers; and a stopper that limits said half-body container from rotating when the protective cover is in a closed condition.

Further, the protruding part may be provided only for one of said two half-body containers, and the protruding part may be one of two protruding parts, each of which are formed on each of said two half-body containers.

Furthermore, the lamp containing part of the protective cover may have a polygonal shape in the cross-section that is perpendicular to the axis direction, and guide rails may be formed in an outwardly projected manner on each edge of said half-body containers, while said stopper is kept by tucking each of the guide rails from both sides.

### BRIEF DESCRIPTION OF THE DRAWINGS

FIGS. 1A-1C are diagrams illustrating examples the lamp protective cover, where FIG. 1A is a frontal view, FIG. 1B is a side view, and FIG. 1C is a side view when the protective cover is open.

FIGS. 2A-2B are diagrams illustrating examples the lamp protective cover, where FIG. 2A is a frontal view, and FIG. 2B is a cross-sectional view along the line 2B-2B′ of FIG. 2A that shows a first embodiment of the lamp protective cover of the present invention.

FIGS. 3A-3B are pattern diagrams to show the effect of the present invention, where FIG. 3A is a comparative example and FIG. 3B is the present invention.

FIG. 4 is a diagram of an embodiment of the lamp protective cover.

FIG. 5 is a diagram of the lamp protective cover of the background art.

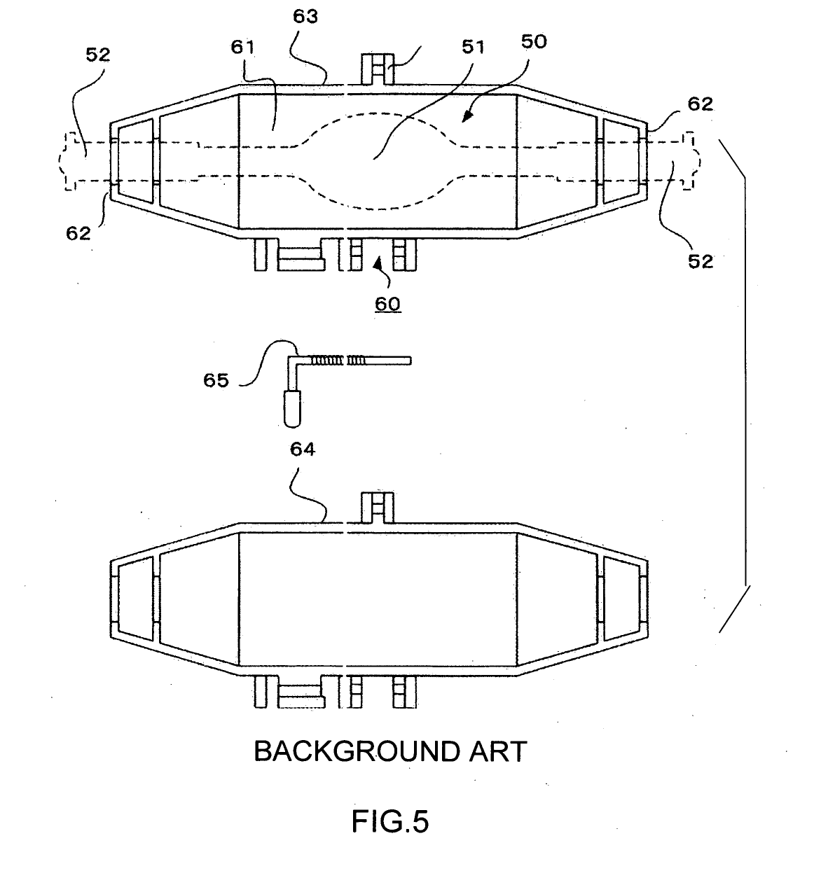

### DESCRIPTION

In accordance with the present invention, the protruding part formed on the half-body container, and the internal wall of the other half-body container, are in contact with each other and during a rupture, a friction force is generated by the high pressure gas. This friction force can reduce the force generated in the direction that the protective cover is to open. At the same time, the gas escapes from the protective cover reducing the internal pressure, thereby maintaining the protective cover without being broken at the moment when the internal pressure is the highest immediately after the rupture. Thus, ramp fragments are not scattered to the surroundings area. In addition, in accordance with the present invention, pressure is generated against the back side of the edge surface of the protruding part. This pressure is a force to close the protective cover, reducing the force to open the protective cover, which is applied to the entire part of the inner wall of the protective cover. In other words, the force, which is applied to the back side of the edge surface of the protruding part may utilized as a force to close the protective cover.

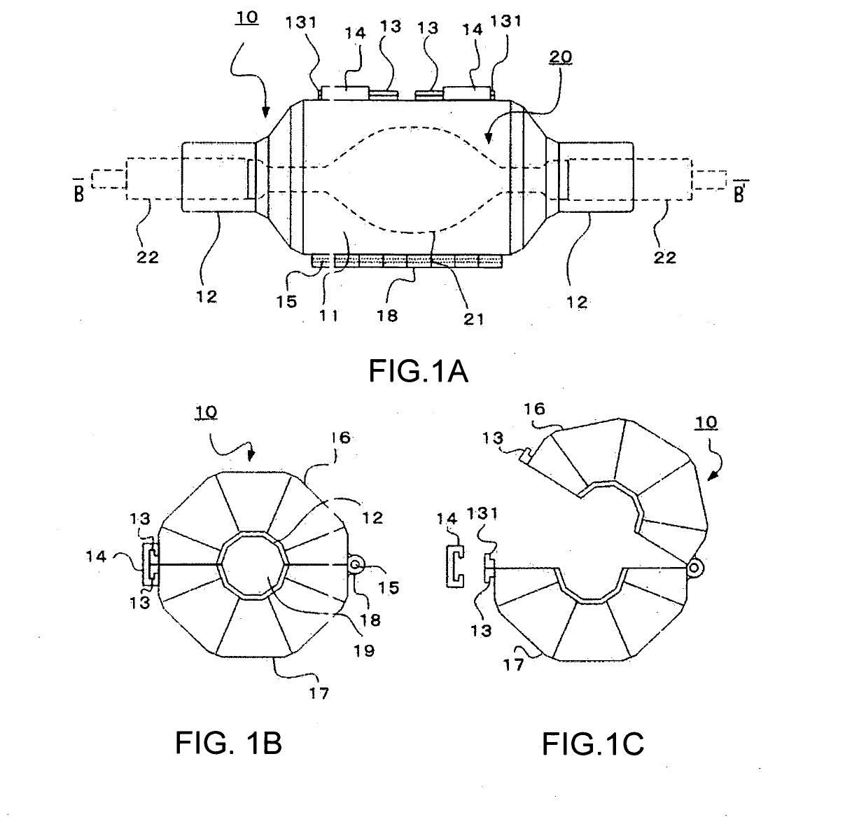

FIGS. 1A-C are diagrams illustrating examples the lamp protective cover, where FIG. 1A is a frontal view, FIG. 1B is a side view, and FIG. 10 is a side view when the protective cover is open. In FIG. 1A, the dotted line shows the position of a contained fixed lamp. In FIG. 1A, the line 1A-1A′ designates the axis direction, and in FIGS. 1B and 10, the axis direction is normal to the plain of the page. In FIG. 1A, protective cover 10 is a container having an approximately octagonal tube made of a transparent resin, for example, polycarbonate, and is comprised of a lamp containing part 11 that surrounds the light emitting part 21 of the lamp 20, and supporting sections 12 and 12, which are narrowed on both edges in the axis direction, and that hold lamp caps 22 and 22, etc. As materials to comprise a protective cover, in addition to PC (polycarbonate), synthetic resins such as ABS (acrylonitrile butadiene styrene), etc., can be preferably used. In addition, the thickness of the protective cover itself is, for example, approximately 3 mm. The lamp containing part 11, located at the center of the protective cover 10 is appropriately structured depending on the size and shape of the lamp. For example, if it is a short-arc discharge lamp, because it has a shape in which the external diameter of the light emitting part is the largest, the internal volume of the lamp containing part 11 becomes also large to accommodate it.

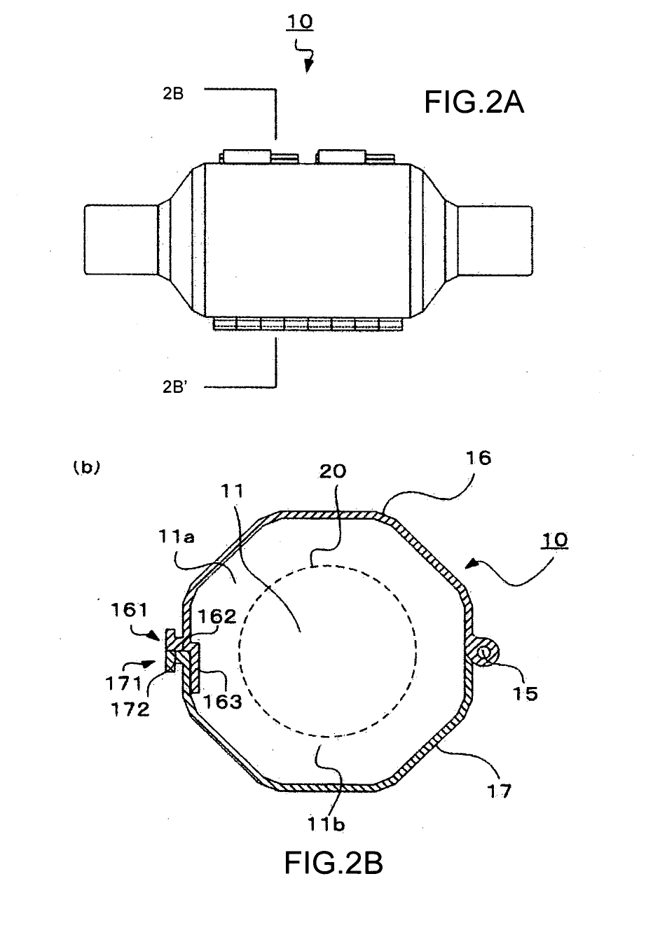

Guide rails 13 and 13 that are outwardly projecting from the edges 161 and 171 of FIG. 2B, are formed along the axis direction on the outside of the half-body containers 16 and 17 of the protective cover 10, and stoppers 14 and 14 are provided so that it can slide on these guide rails 13 and 13. In addition, an axis supporting part 18, in which a through hole is formed in the axis direction with a shaft 15, which is a pivot axis, inserted within, is formed in an integrated manner with the protective cover 10 and in an outwardly projected manner.

As shown in FIGS. 1B and 1C, protective cover 10 is comprised of a pair of half-body containers 16 and 17 that are approximately the same shape. Each of the half-body containers has a shape in which the protective cover 10 is cut in half in the longitudinal direction. The half-body containers 16 and 17 are connected to each other in a rotatable manner, by the axis supporting part 18 with the shaft 15 inserted as the center axis, and can be opened and closed freely in the rotational direction.

Under the condition when the protective cover 10 is closed, the guide rails 13 and 13 that are formed on each of the half-body containers 16 and 17 come in contact so that they are coupled to form a T-shape. On a part on the guide rail in the axis direction, a stopper supporting part 131 is formed, which has a T-shape even under the condition when the protective cover is open, and a guide rail part is not formed on the half-body container that corresponds to the part where this stopper 131 is formed. In other words, under the condition when the protective cover is open, the guide rails 13 and 13 are separated, and at this time, stopper 14, which has an approximate U-shape, escapes to and is retained at the stopper supporting part 131. When the protective cover is closed, the stopper 14 slides from the stopper supporting part 131 to the guide rails 13 and 13 side, and holds guide rails 13 and 13 in a manner in which the stopper 14 clips the guide rails 13 and 13 from both sides. As described above, under the condition in which the stopper 14 is supporting the guide rails 13 and 13, the movement of each of the half-bodies 16 and 17 in the rotating direction is limited. To open the protective cover 10, the lock is released by sliding the stopper 14 in the axis direction, and moving it onto the stopper supporting part 131. When such stopper 14 is used, regardless of the open or closed state, the stopper and protective cover do separate, allowing easy handling. The lock mechanism of the protective cover 10 is not limited to this embodiment and other structures may be employed appropriately.

The edge in the axis direction of the supporting part 12 is open and an opening 19 is formed. This opening 19 is a hole by which, when a lamp 20 is placed in the protective 10, the seal and cap 22 of the lamp 20 project outward. A gap is created between the inner wall of the supporting part 12 and the lamp. During the rupture of the lamp 20, gas escapes from this gap thereby gradually reducing the pressure inside the protective cover 10. A supporter (not shown in the drawings) to support the lamp can be provided at the supporting part 12. In that case, it can have a structure with a hole or the like, on the supporter for gas to escape.

FIGS. 2A-2B are diagrams illustrating examples the lamp protective cover, where FIG. 2A is a frontal view, and FIG. 2B is a cross-sectional view along the line 2B-2B′ of FIG. 2A that shows a first embodiment of the lamp protective cover of the present invention. In the cross-section shown in FIG. 2B, the protective cover 10 has an approximate octagonal outline shape in general, and inside the upper half-body container 16, a space that becomes lamp containing part 11a, and inside the lower half-body container 17, a space that becomes lamp container part 11b are formed. Thus, the edge surface parts 162 and 172, which extend along the axis direction and are formed on the edge surface of the edges 161 and 171, come in contact and comprise the lamp containing part 11, which is for the entire protective cover 10. On the edge 161 of the half-body container 16, a protruding part 163 that extends from edge surface part 162 to the lamp containing part 11, is formed. More specifically, the protruding part 163 has a surface that continues to the edge surface part 162 of the edge 161 of the upper half-body container 16, and has a shape with a hanging tongue downward to the bottom of the page. This protruding part 163 either comes in contact with or is adjacent to the inner wall near the edge 171, which is a continuous surface with the edge surface 172 of the edge 171 of the other half-body container 17. In other words, the edge surface 162 and edge surface 172 are not necessarily intimately attached always, and it is acceptable as long as they are in a position so that they are pushed against each other when the pressure inside the protective cover increases during a lamp.

It is preferable that the protruding part 163 that is formed on the entire part in the axis direction in the lamp containing part 11, comes in contact with the inner wall of the other half-body container 17 along the entire part in the axis direction, nonetheless, it is also acceptable that the protruding part 163 is formed intermittently, in which a part of it is not continuous in the axis direction.

Lamp 20 is placed at the center of the protective cover 10, and therefore, the protruding part 163 is provided so that it does not interfere with this.

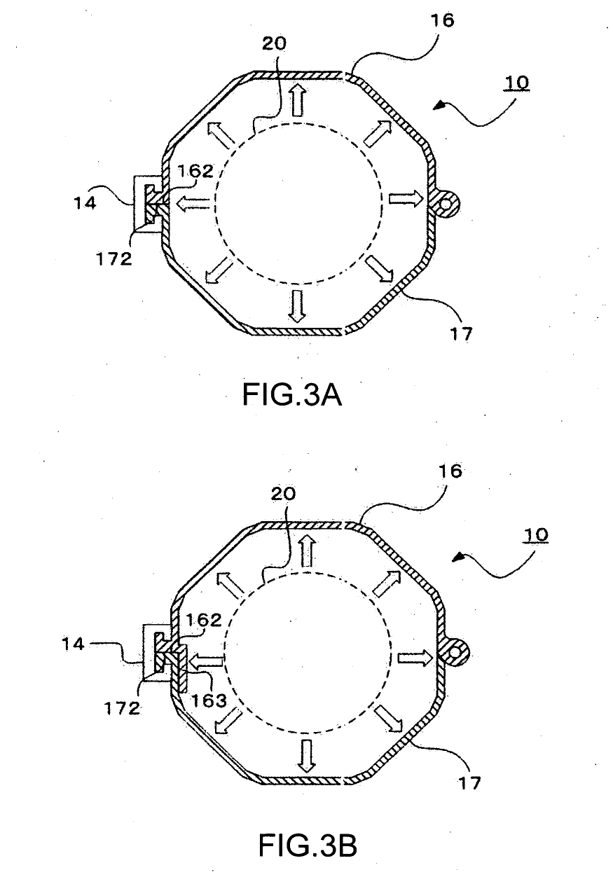

FIGS. 3A-3B are pattern diagrams to show the effect of the present invention, where (a) is a comparative example and B is the present invention. FIG. 3A shows a protective cover without having a protruding part, as a comparative example. FIG. 3B shows the protective cover of the present invention as with FIG. 2B. In FIG. 3A, when lamp 20, in which a gas is enclosed in a luminous tube at an inner pressure that is higher than the atmospheric pressure, for example, a static pressure of 0.5 MPa to 2.0 MPa, is ruptured inside the protective cover 10, even after the gas is emitted inside the protective cover 10, the pressure inside the protective cover 10 momentarily and significantly exceeds the atmospheric pressure. The gas is emitted in all directions, and a load in the direction to open the cover is applied to the inner wall of the protective cover 10.

Here, inside the protective cover 10, there is no part that resists against the force by such gas pressure. Therefore, the gas pressure directly works against the inner wall of the protective cover 10. The stopper 14 is no longer able to endure the force and it comes off the guide rail by breaking. Thus, the protective cover 10 opens. In addition, even if the stopper 14 is not broken, but the guide rail 13 cannot endure the pressure and break accordingly, then protective cover 10 opens.

The opposite side, with a connection by shaft 15, is maintained by the shaft 15, which is inserted entirely into the axis direction, and compared to the side where stopper 14 is provided, it has a relatively high durability and therefore it is difficult to be open.

As shown in FIG. 3B, in accordance with the present invention, a protruding part 163, having a surface continuing from the edge surface part 162 of the half-body container 16, is formed. When the protective cover 10 is closed, this protruding part 163, for example comes in contact with the inner wall of the other half-body container 17. As in FIG. 3A, when a lamp 20 is in the protective cover 10, a load in the direction to open the cover is applied to the inner wall of the protective cover 10. At this time, there is a half-body container that is made of a resin having a certain plasticity, and a protruding part 163 that is deformed and pushed against the inner wall surface of the half-body container 17.

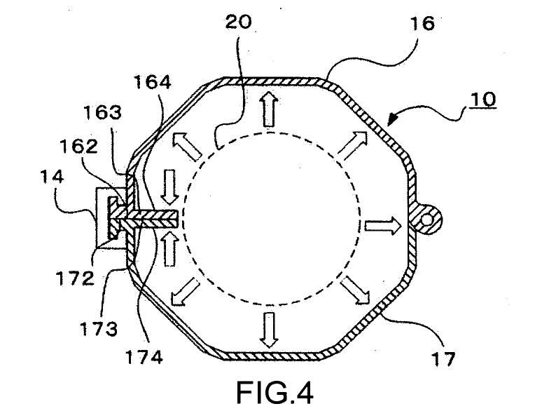

The protruding part 163 that is pushed against the inner wall surface comes in contact with it and a friction force is generated on the surface. This friction force becomes stronger as the gas pressure that presses the protruding part 163 becomes higher. Because the friction force interferes with the force to open the protective cover 10, it can reduce the forces that are applied to the stopper and guide rails during the rupture of the lamp 20. At the same time, the gas escapes from the openings 19 and 19 of the supporting parts 12 and 12, which are provided on both edges of the protective cover 10, allowing the inner pressure to decrease so that the protective cover 10 is kept without being broken at the moment of the highest inner pressure, immediately after the rupture, and thus, lamp fragments are not scattered to the surrounding area. The protective cover 10 is made up of a resin having a plasticity, and in particular, the lamp containing part 11 is formed with a cross-section having a polygonal shape that is perpendicular to the axis direction, and therefore, it has room to be deformed and expand in a round shape. Because of this, it has an effect that the protective cover 10 is deformed by expanding into a round shape, reducing the impact at the moment of the lamp rupture. FIG. 4 is a diagram of an embodiment of the lamp protective cover. As with FIG. 2B, it is a cross-sectional view that is perpendicular to the axis direction of the lamp protective cover. It also serves as a pattern diagram to show the effect. The structure that is explained in FIG. 2B is the same as the present figure and therefore, the explanation is omitted.

In this Figure, on both of the pairs of the half-body containers 16 and 17, plate shaped protruding parts 163 and 173, which are extended into the lamp containing part 11, which continue from the edge surfaces 162 and 172 of the edges 161 and 171, is formed. Under the condition in which the protective cover 10 is closed, these protruding parts 163 and 173 come in contact with each other by edge surface parts 162 and 172. In addition, protruding parts 163 and 173 are formed entirely along the axis direction.

As in FIG. 3, when a lamp ruptures inside the protection cover 10, a load of high pressure gas is applied to the inner wall of the protective cover. At this time, pressure is applied to the back sides 164 and 174 of the edge surface parts 162 and 172 of the protruding parts 163 and 173. This pressure is a force to close the protective cover 10, and it reduces the force to open the protective cover 10, which is applied to the entire inner wall of the protective cover 10. In addition, the friction force generated at the edge surface parts 162 and 172 due to the pressure applied to the protruding parts 163 and 173 makes the protective cover 10 difficult to open. As described above, in the present embodiment, in addition to the similar effect of the first embodiment, the pressure that is applied to the back surface of the edge surface of the protruding part can be utilized as a force to close the protective cover.

It is preferable that the protruding parts 163 and 173 are formed entirely in the axis direction in the lamp containing part 1, and come in contact with the inner wall of the other half-body container entirely in the axis direction, nonetheless, it is acceptable that they are protruding parts that are intermittently formed in which parts of them are not continued.

The preceding description has been presented only to illustrate and describe exemplary embodiments of the present lamp protective cover. It is not intended to be exhaustive or to limit the invention to any precise form disclosed. It will be understood by those skilled in the art that various changes may be made and equivalents may be substituted for elements thereof without departing from the scope of the invention. In addition, many modifications may be made to adapt a particular situation or material to the teachings of the invention without departing from the essential scope. Therefore, it is intended that the invention not be limited to the particular embodiment disclosed as the best mode contemplated for carrying out this invention, but that the invention will include all embodiments falling within the scope of the claims. The invention may be practiced otherwise than is specifically explained and illustrated without departing from its spirit or scope.

What is claimed is:

1. A protective cover that surrounds a light emitting part of a lamp, comprising:
an axis;
two resin half-body containers that freely open and close and that connect in a rotatable manner around said axis;
a lamp containing part provided inside said half-body containers;
two edge surface parts that are each respectively located at edges of said lamp containing parts, that are adjacent when the protective cover is in a closed position, and that extend in an axis direction;
a protruding part that extends perpendicularly to said axis direction toward the lamp containing part from at least one of the half-body containers; and
a stopper that limits said half-body container from rotating when the protective cover is in a closed condition.

2. The protective cover according to claim 1, wherein said protruding part is provided only for one of said two half-body containers.

3. The protective cover according to claim 1, wherein said protruding part is one of two protruding parts, each of which are formed on each of said two half-body containers.

4. The protective cover according to claim 1, wherein the lamp containing part has a polygonal shape in a cross-section that is perpendicular to the axis direction.

5. The protective cover according to claim 1, wherein a guide rail is formed in an outwardly projected manner on an each edge of said half-body containers, and said stopper clips each of the guide rails from both sides.
